(19) United States
(12) Patent Application Publication
(10) Pub. No.: US 2018/0329605 A1
(43) Pub. Date: Nov. 15, 2018

(54) ARRANGING GRAPHIC ELEMENTS WITHIN A USER INTERFACE FOR SINGLE HANDED USER TOUCH SELECTIONS

(71) Applicant: salesforce.com, inc., San Francisco, CA (US)

(72) Inventor: Jujjuri Venkateswararao, Beaverton, OR (US)

(73) Assignee: salesforce.com, inc., San Francisco, CA (US)

(21) Appl. No.: 15/595,006

(22) Filed: May 15, 2017

(51) Int. Cl. G06F 3/0481; G06F 3/041; G06F 3/0484

(52) U.S. Cl. CPC G06F 3/04817; G06F 3/0412; G06F 2203/04803; G06F 3/04842; G06F 3/0416

(57) ABSTRACT

A method and system for arranging, on a display of a device, graphic elements within a user interface (UI) requiring a touch for selection. Initially, receiving, from sense elements at edges of the display of the device, signals indicative of whether the device is in a right hand or in a left hand of the user when the user is making single handed selections by touch. Then, determining by the signals whether the device is in the right hand or left hand of the user. Next, arranging the graphic elements of the UI, to allow for single handed selections with a greater ease by the user in the right hand or left hand by arranging in the first arrangement, the graphic elements for accessing by fingers of the right hand of the user and in the second arrangement, the graphic elements for accessing by fingers of the left hand.

### TECHNICAL FIELD

Embodiments of the subject matter described herein relate generally to user interfaces in displays of devices and more particularly to automated arrangements of graphic elements requiring touch selections within the user interfaces of the displays for access by single handed operations of the user when making the touch selections.

### BACKGROUND

An increasing number of devices utilize touch screen technologies in the display to allow a user to interact with features of apps. For example, a device, likely of a mobile device type, is often cradled in the palm of one of the hands of a user such that the user can support and hold the device in the palm area of the user hand and while doing so, manipulate fingers of the one hand to touch portions of the display of the device which is cradle by the supporting one hand. Further, the user by touch operations of the fingers and more particularly the thumb associated with the one hand doing the cradling of the device can make selections by touch in a one-handed manner on the display. During such one-handed touch selections, often it is the thumb that is customarily used by the user for the touch selections because the other fingers along with the palm of the hand of the user are predominantly used to cradle the device.

A drawback which occurs when making selections using the thumb in a one-handed operation of the device, is that in some cases, the user cannot reach portions of the display by the thumb where selection elements are displayed. This is because these portions of the display are outside a region defined by the capabilities of the hand size and dexterity of the user in relation to the display and the width or height of the display of the device. In such instances, the user is no longer able to manipulate some of the graphic element by thumb selections on the touch display of the device by a single hand but must resort to using the fingers of the other hand in conjunction with the hand cradling the device to make the selections. Hence, this leads to inefficiencies as the user must use both hands to make selections on the display rather than having a free hand for other actions.

Therefore, it is desirable to prevent necessitating the use of the fingers of both hands to make such selections and subsequent two handed operations of touch selections on the displays of the device by dynamically changing the placement or arrangement of various graphic elements used for selection to display the graphic elements in locations accessible by the thumb or other fingers of the one hand which is also cradling the device so that single handed operations when making selections are permissible.

It is desirable to utilize edging sensing features of devices to make right and left hand user arrangement determinations and automatically reconfigure and change the placement of graphic elements for selection found on user interfaces to allow for one hand touch operations.

It is desirable when changing the cradling of the device from either hand to in such instances recognize the change and change the placement graphic elements on the user interface of the device.

It is desirable to integrate routines responsive to a right or left hand cradling of a device to display a right handed or left handed configuration of graphic elements of a user interface in apps, in the OS or even in the mobile client so that the different configurations can be seamlessly integrated when executing various application processes.

It is desirable to integrate apps and routines for arranging right and left hand configurations of graphic elements for access and use in a multi-tenant computing environment.

Current systems fail to provide an adequate solution for placing and arranging elements for selection in user interfaces of devices. Hence, systems and methods are thus needed which address these shortcomings.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram illustrating cradling a device and making one-hand touch selections of graphic elements in a user interface on a display of a device in accordance with an embodiment;

FIG. 2 is a diagram illustrating changing the arrangement of selection elements in a user interface to a target area on a display of a device in accordance with an embodiment;

FIG. 3 is a diagram illustrating changing the arrangement of selection elements in a user interface to a target area on a display of a device in accordance with an embodiment;

FIG. 4 is a user interface for defining attributes for arrangement configurations of selection elements in a user interface for display in a device in accordance with an embodiment;

FIG. 5 is a flow chart of an exemplary method for automatically arranging selection elements in a user interface on a display of a device in accordance with an embodiment;

FIG. 6 is a flow chart of an exemplary method for automatically arranging selection elements in a user interface on a display of a device in accordance with an embodiment;

FIG. 7 is a schematic block diagram of software and hardware modules of a device in accordance with an embodiment; and

FIG. 8 is schematic diagram of a multi-tenant computing environment in accordance with an embodiment.

### DETAILED DESCRIPTION

A significant factor affecting the manner how a device is used is the hand posture of the user and whether the user manipulates a device with one or two hands and the subsequent resulting number of fingers used for the user manipulation of elements in a display of the device. This has an effect of performance and usage of the device particularly when the user is attempting to multi-task when operating the device and requires a free hand for other activities. That is, there may be delays in operating the device when the user is performing other tasks with the other hand when multi-tasking if not all the graphic elements on the display of the device are easily accessible by a single hand during the device operations. While it is contemplated that the disclosed subject matter is implemented in a device which is a mobile both supported and operated by a single hand of a user, and most likely the scenario envisioned is when holding and operating a mobile smart phone; other ways of deploying the disclosed subject are also feasible. For example, it is entirely possible for the subject matter to be deployed in or integrated into touch screen control pads in systems or equipment that are not portable like vehicle control pads or other types of instrumentations where the sensors from sensing events such as touch operations may enable processors of the device to be configured to discern by computer algorithms to determine right or left hand use by an operator by the touch actions sensed. In these cases, the sensors of the device would omit the steps of detecting or discerning whether the device is held in a right or left hand of the operator but rather using computer algorithmic solutions determine the hand use by hand and finger contact or related characteristics of the device during device operations.

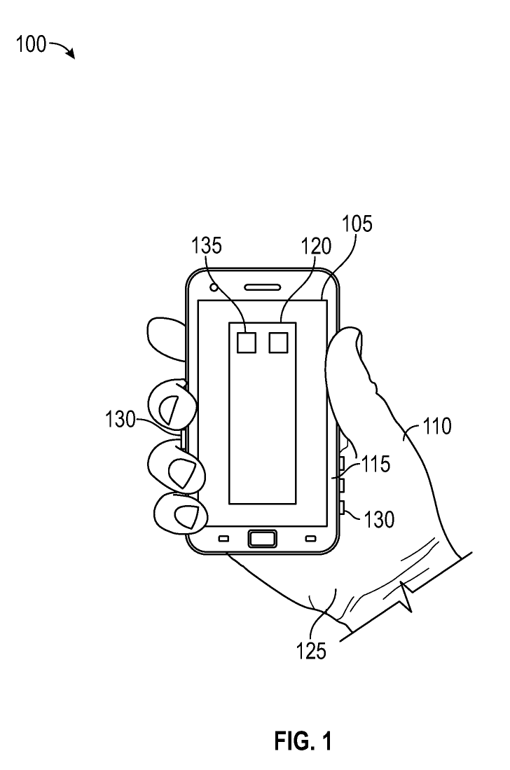

With a reference to FIG. 1, FIG. 1 is a diagram illustrating a device 100 which is held in the cradle of the palm 125 of a user using a single hand 110 to hold and cradle the device 100. The device has a display 115 and within that display 115 is a target area 120 which is the area that is accessible by fingers of the one hand of the user on the display 115 when the one hand is also cradling the device 100. The device 100 may be of a variety of different types manufactured devices comprising an IPHONE® 14, IPHONE® I5S, IPHONE® I6S, IPAD®, HTC® ONE X, SAMSUNG® GALAXY™ S5, LENOVO® VIBE™ X etc.

Further, the device 100 may include any mobile or connected computing device including “wearable devices” having an operating system capable of running mobile apps individually or in conjunction with other mobile or connected devices and an associated display that lends itself to a right or left arrangement of graphic elements on the display. Examples of “wearable devices” include GOOGLE GLASS® and ANDROID™ watches. Typically, the device 100 will have display capabilities such as a display screens that can be operated by one hand; that is the device may have associated keyboard functionalities or even a touchscreen providing a virtual keyboard and buttons or icons on a display 115 which can be operated by the left or right hand. Many such devices 100 can connect to the internet and interconnect with other devices via Wi-Fi, Bluetooth or other near field communication (NFC) protocols. Also, the use of cameras integrated into the interconnected devices and GPS functions can be enabled and likewise operational buttons on the display 115 can be arranged for one-hand manipulations.

In exemplary embodiments, the display 115 is a touch screen display which may be a liquid crystal display (LCD), organic LCD (OLED) display, resistive and capacitive touch displays, active light emitting displays, retinal displays, etc. The display 115 is a touch-sensitive in a display area in which information may be displayed, and in embodiments may be a curved type of display 115, or other additional types of display 115 having display areas extending around the periphery or edges of the display area.

The display 115 contains sensors 130 which are capacitive or of optical type of sensing elements that are responsive to contact by the user. Alternatively, the sensors 130 can utilize any suitable type of sensing or detecting technology to support the methodology described herein. The contact may be in the form of a touch by the thumb or other fingers of the single hand 110 of the user. In addition, the sensors 130 may be found throughout the top surface of the display as well as at the edges of the display 115. Hence, the display 115 may contain an array of sensors 130 on the surface and on the sides; in the case of the sensors 130 on the side of the display 115, such sensors 130 on the side are used for edge detection and often found in a display 115 with a curved display characteristic where the curvature of the display allows part of the surface of the display 115 to surround the edges of the device 100. The display 115 therefore is capable of detecting edge to edge detection from each side of the display 115. For example, device may include edge detection features and further may include enhancements with respect to edge detection that are touch sensitive and can recognize or even anticipate hand use of the device by triggering of sensor events.

The display 115 may also include a graphic user interface 105 (GUI) where the GUI 105 can be considered a user interface for user interactions where the user manipulates graphic elements 135 on the display 115 of the device 100. The GUI 105 is made up of graphic elements 135 and other components used for user manipulations by touch to make selections which change a state of an app associated with the graphic elements 135. The graphic elements 135 of the GUI 105 are essentially the graphic elements 135 that the user controls to interact with the device 100 from the display 115 to apps via signals generated by processers of the device 100 which are in modes responsive to the user touch selection actions or requests of the graphic elements 135.

A user touch contact or touch event may be detected by sensors 130 which are touch sensitive on the display 115. In such instances, a processor (not shown) may determine attributes of the touch, including a location of a touch. The touch may be detected from any suitable object, in this instance, on a hand such as a finger, thumb, appendage, or other items, depending on the nature of the display 115.

In an exemplary embodiment, the graphic elements 135 may also comprise a pointer which is another type of graphic element 135 that appears like a symbol on a display and that allows a user to move and to select objects and to also select commands. Additionally, an icon which is another type of graphic element 135 which can be displayed on the display 115 and represents a type of an object or an available function for a user selection. That is, an icon may be considered a type of graphic element 135 that is customarily a small JPEG type image that represent commands or files. In addition, other graphic elements 135 include menus which are a listing of command functions available for selection by a user. The menus allow users to choose between different functions they want to run in an application or operating system. All these types of graphic elements 135 whether the graphic elements 135 are pointers, icons or menus must be within a target area 120 for one handed user selection.

The target area 120 is the region of the display 115 that is easily accessible by the thumb or other fingers of the user when operating the device 100 by single handed operations. That is, graphic elements 135 in the target area 120 are accessible by “touch” usually by the thumb but also by other fingers of the user while the user is cradling the device 100 and operating the device 100 by one hand.

Further, in single one handed user operations gestures which are a type of touch can be detected by the display 115 by user touches. Briefly, a gesture is a type of touch on a display 115 which can be identified by the touch-sensitive capabilities of the display 115 that begins at one location on the display 115 and continues while still touching the display 115 to another location on the display 115. A gesture may be identified by sensors 130 of the display processing touch attributes of the gesture including location of the start and end, as well as the distance while touching, duration, and direction of the finger movement. A gesture is often commonly referred to as a swipe and a user performs a swipe motion generally with a one-handed operation. In addition, the detection is not limited to gestures but may include non-touch gestures made during single hand user operations. For example, gesture movements from motioning of the device 100, gesture motions of camera frames detected, or gestures of motions of the light from the display 115 or camera of the device 100 etc.

For example, in an exemplary embodiment, the pointing and touching actions of index fingers is significantly better than similar actions of a thumb, however pointing actions require using two hands versus one hand. Hence, to replicate similar performance with a single hand operation necessitates a better performance of the user of a single-handed thumb action. To perform actions in a better performance requires a better placement of the graphic elements on the display 115 of the device 100 can accentuate a better single handed thumb performance. Hence, by changing the placement of the graphic elements 135 to within a target area 120, a better performance by a single-handed thumb operations can be achieved.

With a continued reference to FIG. 1, the sensors 130 are arranged surrounding the edge of the display 115 and in instances, the sensors 130 may be optical or infra-red (IR) sensors 130 responsive to the touch or pre-touch of the user hand or fingers movement and not only the actual user touch. In exemplary embodiments, the sensors 130 are capable of sensing pre-touch conditions or actions of the user anticipating touch. That is, there may be instances when the user is about to cradle the device 100 in the palm 125 or hold the device in other manners. As such, the sensors 130 are capable of detecting conditions of pre-touch and generating signals responsive the pre-touch conditions which in turn using processors of the device 100 allow for determinations of one handed operations.

In exemplary embodiments, additional types of sensors 130 such as force sensors may be disposed in suitable locations of the device 100. For example, suitable locations may include between the display 115 and a back of the device 100 to detect a force imparted by a touch on the entire surface of the display 115. The sensor may be a piezoelectric or piezo-resistive device, pressure sensor etc. Information gleaned about the force which is associated with a detected touch may be used to make determinations of one handed operations. For example, a touch that does not meet a threshold maybe one kind of option, while a touch that meets a higher threshold may allow determinations of right or left handed operation by the user. Alternately, the force gripping a device 100 may be different in two handed operations as in single handed operations, the thumb may apply force in one direction and the hand must grasp the device 100 in another direction resulting in more or different sets of forces. Theses more or different sets of forces can be processed by the device 100 to determine single handed use by the user as well as right or left handed use.

In instances, the user may not actually cradle the device 100 in the palm 125 but may grip the device by the fingers or other parts of the single hand 110 of the user. In such instances, the sensors 130 are capable to detect attributes by the gripping or holding of the device 100 and associate the detected attributes with either the right or left hand of the user. In other words, because the sensors 130 are present throughout the surface of the display 115 as well as the edges of the display 115; various ways of holding the device 100 and associated attributes can be discerned and processed leading to a recognition of the user holding the device 100 in the right or left hand.

In an exemplary embodiment, haptic functions of the device 100 may be used for detecting operation by the user in the left or right hand. For example, algorithmic solutions may be applied to vibration absorption is proportional to the amount of pressure being applied to the screen by types of grip applied to the device in the right and left hand. The damping effect is measured using the gyroscope of the device 100.

In an exemplary embodiment, the target area of the device 100 may be further divided into different subsections for placement of the graphic elements 135. That is, the graphic elements 135 can be prioritized in the placement for easier access and operation by the user in single-handed operations hence again accentuating the single-hand operation actions of the user.

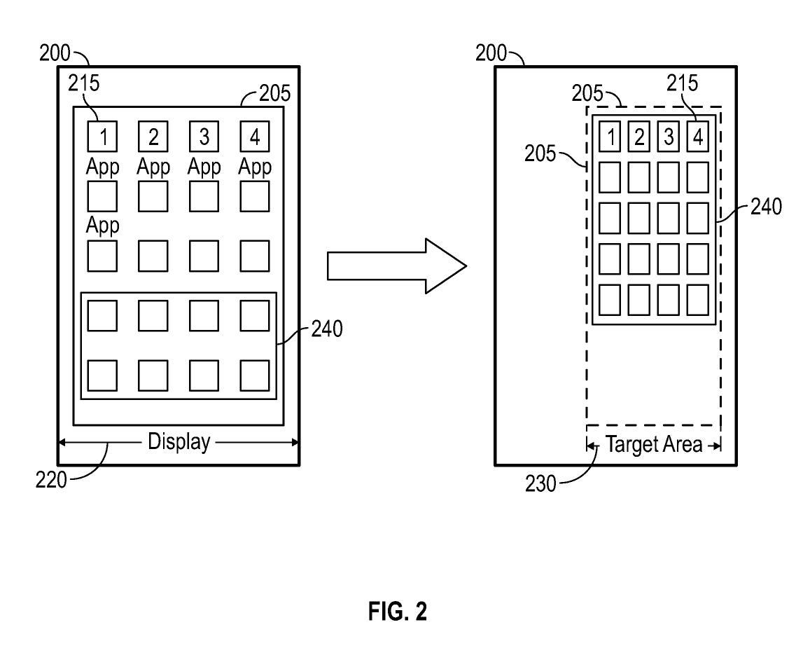

With a reference to FIG. 2, FIG. 2 illustrate changes in the arrangement of selection elements in a user interface to a target area 230 on a display 220 of a device 200 in accordance with an embodiment. In exemplary embodiments, changing the arrangement of the graphic elements 215 for selection comprises: shifting the graphic elements 215 to be within the target area, re-arranging the graphic elements 215 to be with the target area 230, or other multitudes of combinations of shifting, arranging and re-arranging the graphic elements 215 for selection to be in a target area 230. In addition, changing the arrangement of graphic elements 215 for selection may include changing all or a limited number of the graphic elements 215, or alternately eliminating, excluding or adding to the number of graphic elements 215 for selecting within a target area 230.

In such instances, there may be sets or individual graphic elements 215 which have not changed in the arrangement, or have been shifted or modified in a multitude of manners to be within the target area 230 to enhance ease of operation. Additionally, the changes to the arrangement of the selection elements may include eliminating and/or combining graphic elements 215 for selection when arranging, rearranging or shifting the graphic elements 215 for accessibility in the target area 230. Additionally, the graphic elements 215 may be changed in size or even shape and the change may affect some, a substantial number or all the graphic elements 215 during the arranging, rearranging and shifting to optimize the number and operation of the graphic elements 215 in the target area 230. Additionally, the operation states of the selection of the graphic elements 215 may also be re-configured during the changing of the arrangement. For example, more selection states may be configured for selections associated with a graphic element 215 to in instances allow for a lesser number of graphic elements 215 while still maintaining a similar degree of functionality of operations using the lesser number of graphic elements 215. In other words, there are multitude of different ways and combinations of arranging and not arranging, rearranging and not re-arranging, and shifting and not shifting the selections elements with respect to a target area 230 for the right, left and default arrangements to ease single handed operations.

FIG. 2. illustrates a client 205 of an app which may include a user interface consisting graphic elements of apps and in-apps or other types of selectable elements, icons etc. In addition, the client 205 may use a platform which may be configurable for a multitude of mobile operating systems including ANDROID™, APPLE® iOS, GOOGLE® ANDROID™, RESEARCH IN MOTION's BLACKBERRY® OS, NOKIA®'s SYMBIAM™, HEWLET-PACKARD®'s webOS (formerly PALM® OS) and MICROSOFT®'s Windows Phone OS etc.

The client 205 includes a GUI 240 including various graphic elements 215 which may be placed within a target area 230 for convenient access by the thumb of a user. In an exemplary embodiment, the target area 230 is configured for a right hand and hence the target area 230 is within a predefined distance of the right side of the display 220 of the device 200. For example, a right hand (not shown) would cradle the device 200 in the right hand of the user.

With a reference to FIG. 2, upon cradling the device 200, the client 205 responds to commands generated by instructions controlling the GUI 240 set up and shifts the GUI 240 to the right to be with a target area 230 such that the graphic elements 215 of interest are placed in a manner that are accessible by the thumb or other fingers of the right hand. By shifting the GUI 240 and subsequent graphic elements into the target area, the user can hold the device 200 with a single hand and operate actions on the device 200 with a single-handed operation. In an exemplary embodiment, the target area 230 may be not simply a rectangular shape but any amorphous shape that defines a region that is accessible by the thumb or other fingers of a single hand while holding the device 200.

The target area 230 may be defined a subset of the GUI 240 of the client 205 or may include the entire GUI 240 or may be simple a single or set of graphic elements 215.

In an exemplary embodiment, SALESFORCE® LIGHTNING™ is a page architecture that can be used for creating an GUI. For example, in SALESFORCE® LIGHTNING™, the framework includes a set of prebuilt components which can be assembled and configured to form new components in an app. Components are rendered to produce HTML document object management DOM elements within the browser. component can contain other components, as well as HTML, CSS, JavaScript, or any other Web-enabled code. This enables a developer to build apps with sophisticated GUIs 240.

The SALESFORCE® LIGHTNING enables a user to use navigate tools through pages for more easily with space-saving, collapsible left navigation menu, which can be customize for various types of users (such as sales reps, sales manager, or execs). The navigation menu is arranged on the left of the display and can be further arranged to be within the target area 230 so that a user can make navigation selections using one handed operations.

Hence, the client 205 can be configured in a multitude of ways hosted on the device 200 and accessible on the display 220 of the device 200. As explained with the above discussion (of FIG. 1), the display 220 may be shifted into the target area, may simply be a shift to the right or left or the graphic elements 215 may be arranged in a way to allow easier access by the fingers of a single hand while holding the device 200.

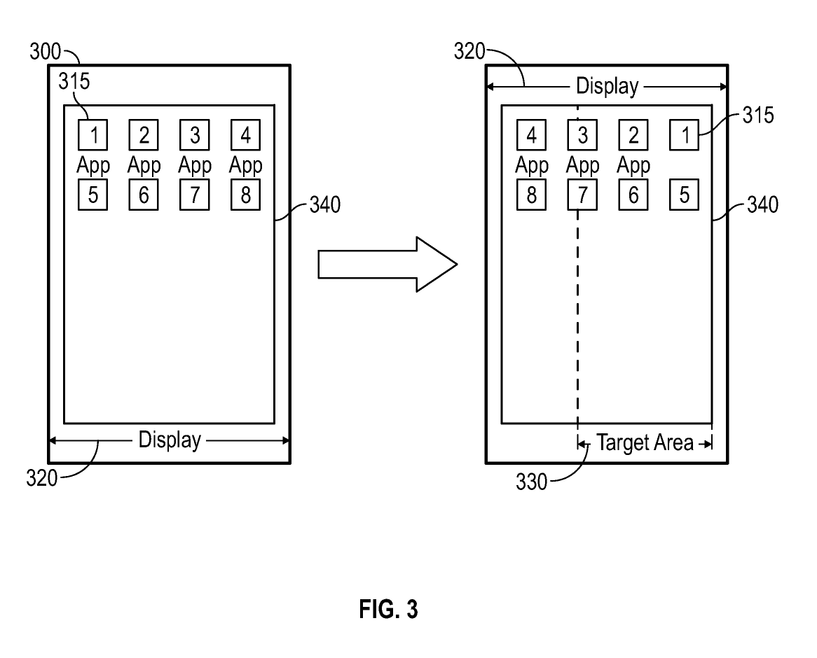

As depicted in FIG. 3, the client 305 responds to commands generated by instructions controlling the GUI 340 to set up and to arrange or to rearrange the GUI 340 in an opposing mirror image configuration. This mirror image configuration would entail the graphic elements 315 of interest originally displayed in a location on one side of the display 320 also described as being on the lateral side of the display 320 exceeding a distance of accessibility by fingers of the hand in which the user is holding the device 300. To remedy the problem, the graphic elements 315 of the device 300 are “flipped” or rearranged to be on the other or opposing lateral side of the display 320 of the device 300 within a closer distance to the supporting hand of the user. Hence, the graphic elements previously outside the target area 330 on the opposing side are now within the target area 330. In other words, what appears to the user, is a 180-degree change of the graphic elements 315 from one side of the display 320 to the other opposing side of the display 320 consistent with the user changing hands of the device 300 from the right to the left or vice versa. Additionally, the recognition automated recognition and further validation of the cradling of the device by the opposing hand. By such, mirror flipping, the user would immediately recognize the change and may additionally recognize by the mirroring of the graphic elements for selection, the graphic elements 315 of the GUI 340 have been rearranged for single handed operations by the opposing hand. In other words, by the rearrangement, and displaying of the rearrangement, the user would likely continue to use the device 300 in one-handed operations leading to greater efficiencies in the device 300 use.

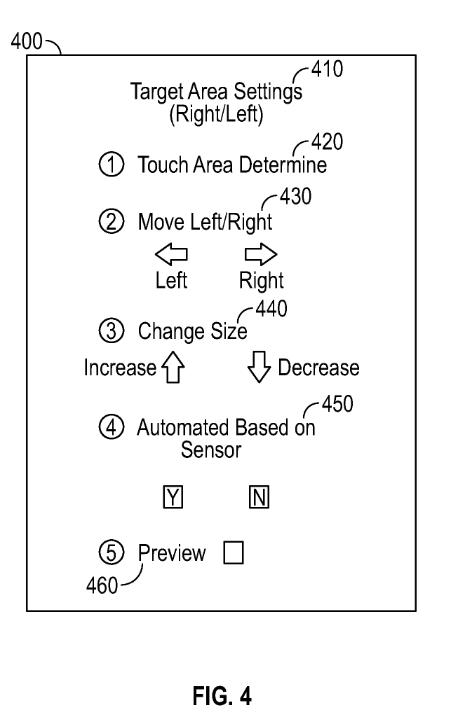

With a reference to FIG. 4, FIG. 4 illustrates a diagram of settings of the GUI 400 for a user to define the target area of on the mobile display. In exemplary embodiments, the target area may have default settings for right and left configurations. Additionally, the target area may be determined by algorithmic solutions of data of user information such as the user height, size, and/or other user characteristics; and the information may also be extracted from prior user input with respect to other settings or from user past interaction usage of the device. The settings of the GUI 400 allow for defining the target area for use in a right configuration or a left configuration of various other GUIs displayed on the device.

The settings of the GUI 400 include a target area placement settings 410, target area determination controls 420, bidirectional controls 430 for moving the target area left or right, and size controls 440 for changing the size of the target area in relationship to the display. In exemplary embodiments, defaults for determinations of the target area may be pre-set, of may be set in an automated manner and may also be device specific. That is, depending on the device being used, the target area may be pre-set to the device type simply by algorithmic solutions that recognize the device type and have stored in memory or may access metrics of the device such as display size, size of the device by model numbers or other descriptive attributes. In addition, a delay may be included, that is the configuration is changed only after a pre-determined delay in attempt to prevent false positives and needless switching of the display from a right to left or vice versa configurations in instances when the user may be switching hands holding the device only momentarily.

The settings of the GUI 400 may also include a variety of personalization options, for example the user may opt in or opt out of the automated configurations by actuation control 450. In addition, the user may preview the target area by preview control 460. The settings of the GUI 400 are not limited to the settings shown, but may include other control types and other settings that are common with setting up user interfaces such as color selections, overlays, etc. in defining the target area and arranging the graphic elements within the target area. For example, the graphic elements may be customized to the color that proves to be more convenient for the user to actuate within the target area or may be set to a size that proves again to be more convenient for actuations. Hence, as explained, the settings of the GUI 400 preferably include of a variety of controls for manipulating the location and size of the target area. Additional exemplary embodiments, may include different ways of defining the target area such as through user contact by touch and outlining a target area, drawing functions that allow a user to draw a target area.

In an exemplary embodiment, additional configuration settings of the GUI 400 include moving the GUI left or right by bidirectional controls 430. In addition, and in conjunction with the GUI movement, the settings can be used to change the size of the graphic elements by size controls 440, so that more graphic elements can fit within the target area or to the right or left.

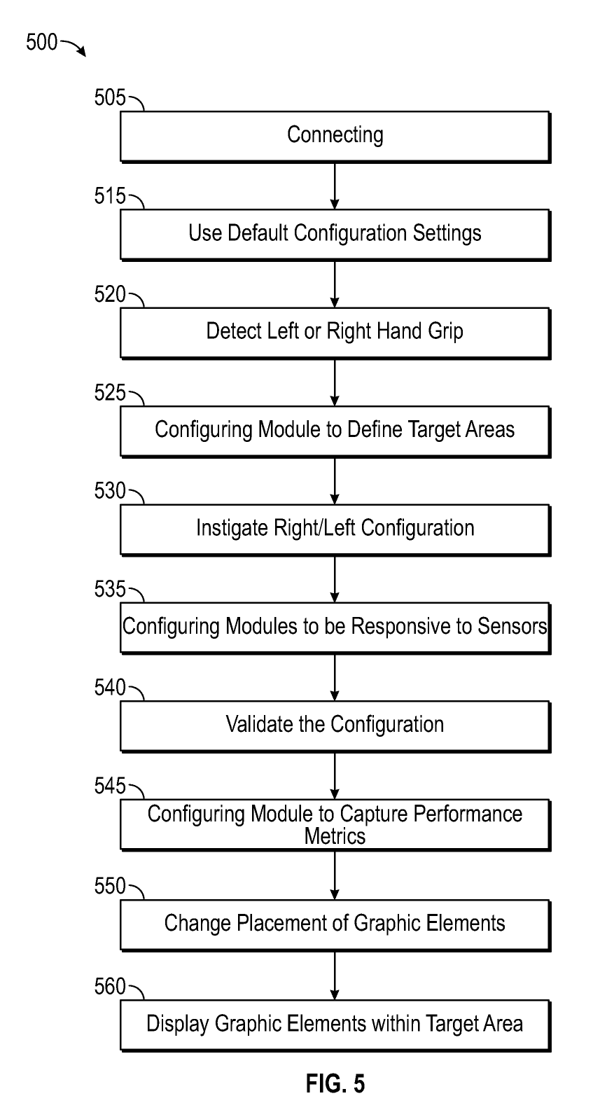

With a reference to FIG. 5, FIG. 5 is a flow chart of an exemplary method 500 for executing the right and left configurations in accordance with an embodiment. More particularly, the exemplary method 500 includes: connecting (Task 505) devices to an app or down loading software modules for configuring user interfaces into right and left arrangements, configuring (Task 515) a first module to connect or integrate the user interfaces displayed on displays of devices to the app or down loaded software module for execution: configuring (Task 520) a second module to implement the configuration modules in the OS systems or in other apps when executing; configuring (Task 525) a third module to define target areas of the configuring software module and other related attributes; configuring (Task 530) a fourth module for previewing the defined target areas with overlays or the like over the display and for adjusting the target area; configuring (Task 535) a fifth module to implement sensors of the mobile with the app for sensing right and left hand configurations and for setting automated settings; configuring (Task 540) a sixth module to implement the setting with other connected devices or upload to personal clouds operations; and configuring (Task 545) a seventh module for processing and capturing performance metrics of the right and left configurations from devices for sending to third party servers to assess user performance in one-handed operations of the right and left configurations.

In an exemplary embodiment, the framework of the processing module for task 545 may consist of executing performance tests that can run on the device, servers, and networks based on web drivers leveraging existing open source browsers and native automations to assess and compare the performance of the user when the device is configured from an original configuration to the right and left configurations to ensure or provide data of better performance of user operations with the graphic elements being rearranged accordingly.

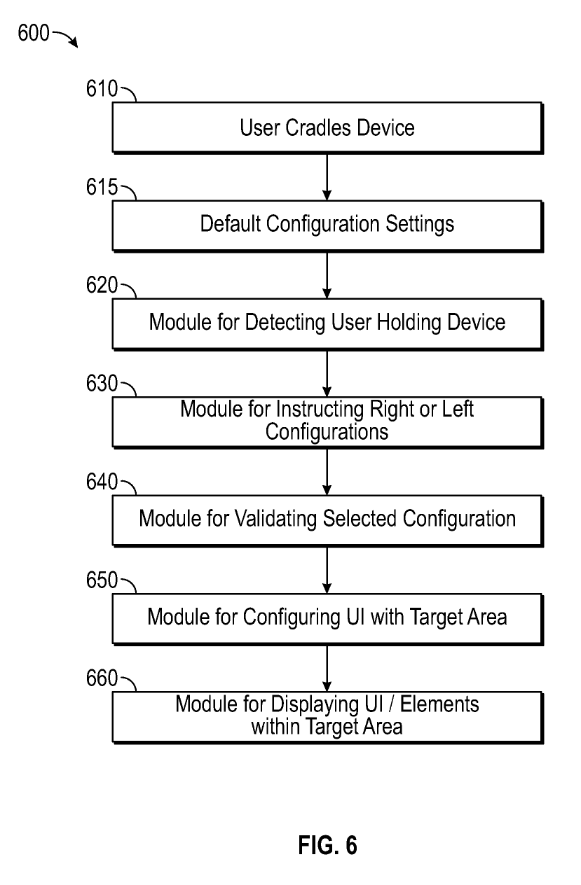

With a reference to FIG. 6, FIG. 6 is a flow chart of an exemplary method for automatically arranging selection elements in a user interface on a display of a device in accordance with an embodiment.

At step 610, the user may pick up or already be holding a device and activate the device. Initially, if the device is unable (for any number of apparent reasons) to detect which hand the user is carrying the device, a default configuration at step 615 is displayed. For example, the user may place the device on the dashboard of an automobile or may place the device is a hold of some sort. Hence, in such instances when there is no detection of one-handed operation, the configuration is set to a default configuration which likely will be a right or left configuration; or in instances, may be an agnostic configuration.

At step 620, the module detects whether the user is holding the device in the left or right hand. In an exemplary embodiment, the touch sensors of the device generate a plurality of signals indicating groupings that indicate the device is being held in the right or left hand. The signals generated upon touch may originate from touch of the palm of the hand when cradling the device. Additionally, signals may be generated from the grip of the fingers when holding the device or the touch of the right or left thumb on the surface of the display of the device upon beginning to actuate the device. Additionally, pre-sensing sensor technology may be utilized using the gyroscopic information when moving the device or the manner the device is being position for viewing.

In alternate exemplary embodiments, gyroscopic and accelerometer sensor information may be processed by algorithmic solutions with thresholds and data sets for ascertaining motions and positions that indicate a right or left handed holding of the device. For example, an accelerometer contained in the device is capable and may be configured to measure linear acceleration of movement, while a gyroscope on the other hand can be configure to measure the angular rotational velocity and send this information to modules (not shown) of the device capable of measuring and receiving data of the rate of change for different aspects of the device leading to determinations of a right handed or left handed configuration being necessitated.

At step 630, the module instructs the processers of the device to instigate a right or left configuration. As mentioned this may be determined by output from various sensors or through complex algorithmic solutions of the data from the device motion, history of use etc. Once a configuration is instructed, the configuration is validated at step 640 for false positives; that is, in certain instances, the user may be holding the device in the right or left hand momentarily but in fact always uses the device in a right or left hand. In such instances, there is no need to switch the configuration if the configuration is determined already as the appropriate configuration. The validation of step 640 may involve delays or a feedback process for monitoring the sensor signals prior to making a change of the arrangement of the element of the GUI. In step 650, the module instructs the GUI to make a change such as changing the placement of the graphic elements so the graphic elements are within the target area. At step 660, the graphic elements are displayed within the target area in response to the information set from step 650.

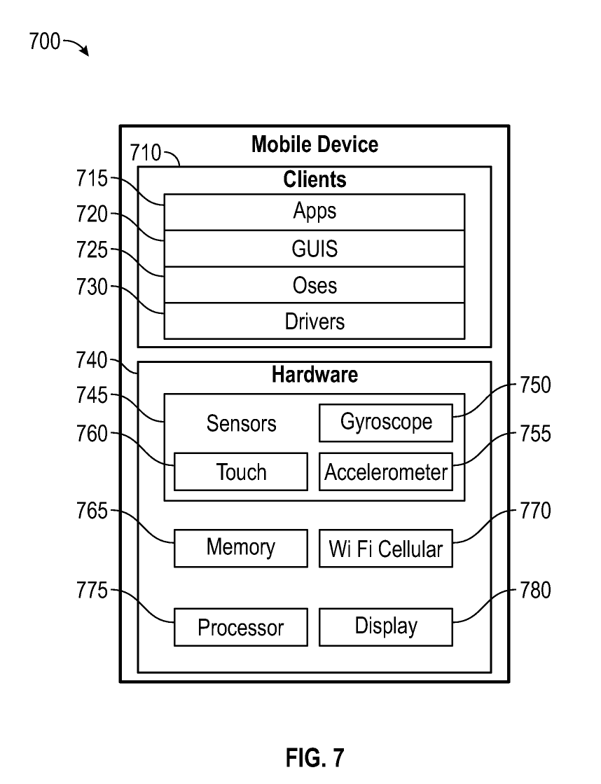

With a reference to FIG. 7, FIG. 7 illustrates a device 700 in accordance with an exemplary embodiment of the present disclosure. The device 700 includes a client 710 comprising a variety of software related modules of apps of the client 710, graphic user interfaces 720 made up of software components, operating systems 725, and software drivers 730 to execute various software routines in conjunction with the operating systems 725, apps 715 and GUIs 720. Additionally, the device 700 includes hardware devices 740 such as sensors 745 comprising touch sensors 760, accelerometers 755 and gyroscopes 750. In addition, local memory 765, connectivity networks of cellular and Wi-fi 770, display 780 and processor 775. The local memory 765 and the client 710 can be integrated in a multi-tenant architecture.

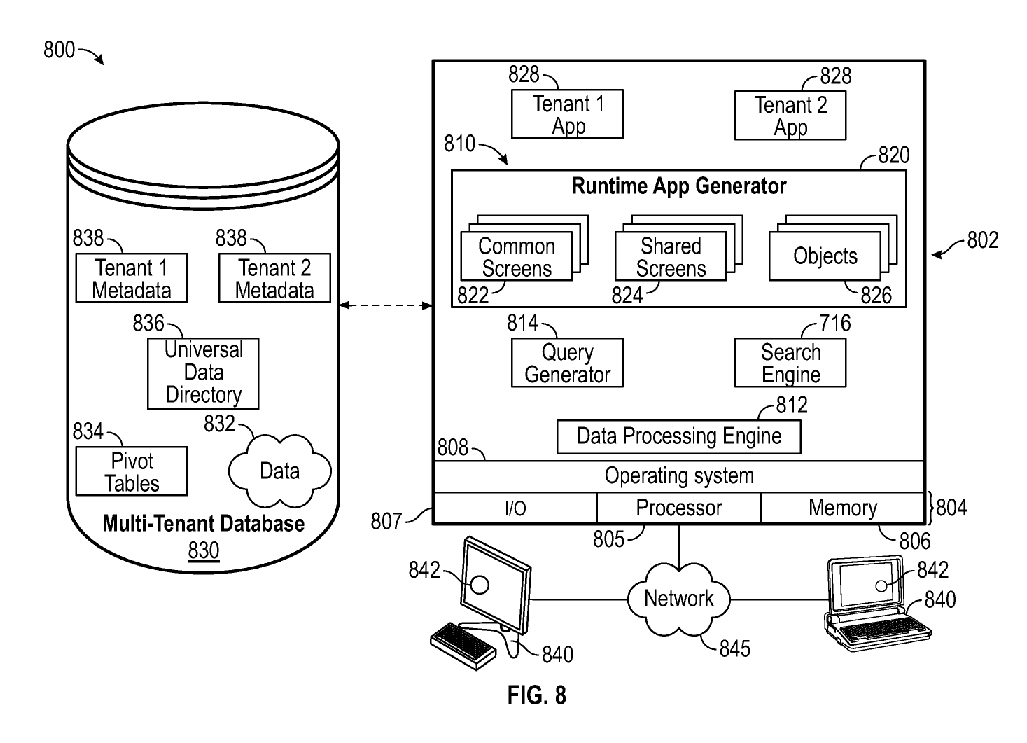

With a reference to FIG. 8, FIG. 8 is a schematic block diagram of a multi-tenant computing environment in accordance with an embodiment for integrating the client 710 (of FIG. 7) and app generator. FIG. 8 is a schematic block diagram of a multi-tenant computing environment for use in conjunction with the communication process of in accordance with an embodiment. A server may be shared between multiple tenants, organizations, or enterprises, referred to herein as a multi-tenant database. In the exemplary disclosure, apps related to right and left arrangements of graphic elements for GUIs may be provided via a network 845 to any number of mobile tenant devices 840, such as tablets, smartphones, Google Glass™, and any other computing device.

Each app 828 is suitably generated at run-time (or on-demand) using a common type of app platform 810 that securely provides access to the data 832 in the multi-tenant database 830 for each of the various tenant organizations subscribing to the service cloud 800. In accordance with one non-limiting example, the service cloud 800 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 830. In this regard, each tenant includes one or more users and/or groups associated with, authorized by, or otherwise belonging to that respective tenant. Stated another way, each respective user within the multi-tenant system of the service cloud 800 is associated with, assigned to, or otherwise belongs to a particular one of the plurality of enterprises supported by the system of the service cloud 800.

Each enterprise tenant may represent a company, corporate department, business or legal organization, and/or any other entities that maintain data for sets of users (such as their respective employees or customers) within the multi-tenant system of the service cloud 800. Although multiple tenants may share access to the server 802 and the multi-tenant database 830, the data and services provided from the server 802 to each tenant can be securely isolated from those provided to other tenants. The multi-tenant architecture therefore allows different sets of users to share functionality and hardware resources without necessarily sharing any of the data 832 belonging to or otherwise associated with other organizations.

The multi-tenant database 830 may be a repository or other data storage system capable of storing and managing the data 832 associated with any number of tenant organizations. The multi-tenant database 830 may be implemented using conventional database server hardware. In various embodiments, the multi-tenant database 830 shares the processing hardware 804 with the server 802. In other embodiments, the multi-tenant database 830 is implemented using separate physical and/or virtual database server hardware that communicates with the server 802 to perform the various functions described herein.

In an exemplary embodiment, the multi-tenant database 830 includes a database management system or other equivalent software capable of determining an optimal query plan for retrieving and providing a subset of the data 832 to an instance of app (or virtual app) 828 in response to a query initiated or otherwise provided by an app 828, as described in greater detail below. The multi-tenant database 830 may alternatively be referred to herein as an on-demand database, in that the multi-tenant database 830 provides (or is available to provide) data at run-time to on-demand virtual apps 828 generated by the app platform 810 as described in greater detail below.

In practice, the data 832 may be organized and formatted in any manner to support the app platform 810. In various embodiments, the data 832 is suitably organized into a relatively small number of large data tables to maintain a semi-amorphous “heap”-type format. The data 832 can then be organized as needed for a virtual app 828. In various embodiments, conventional data relationships are established using any number of pivot tables 834 that establish indexing, uniqueness, relationships between entities, and/or other aspects of conventional database organization as desired. Further data manipulation and report formatting is generally performed at run-time using a variety of metadata constructs. Metadata within a universal data directory (UDD) 836, for example, can be used to describe any number of forms, reports, workflows, user access privileges, business logic and other constructs that are common to multiple tenants.

Tenant-specific formatting, functions and other constructs may be maintained as tenant-specific metadata 838 for each tenant, as desired. Rather than forcing the data 832 into an inflexible global structure that is common to all tenants and apps, the multi-tenant database 830 is organized to be relatively amorphous, with the pivot tables 834 and the metadata 838 providing additional structure on an as-needed basis. To that end, the app platform 810 suitably uses the pivot tables 834 and/or the metadata 838 to generate “virtual” components of the virtual apps 828 to logically obtain, process, and present the relatively amorphous data from the multi-tenant database 830.

The server 802 may be implemented using one or more actual and/or virtual computing systems that collectively provide the dynamic type of app platform 810 for generating the virtual apps 828. For example, the server 802 may be implemented using a cluster of actual and/or virtual servers operating in conjunction with each other, typically in association with conventional network communications, cluster management, load balancing and other features as appropriate. The server 802 operates with any sort of processing hardware 804 which is conventional, such as a processor 805, memory 806, input/output features 807 and the like. The input/output features 807 generally represent the interface(s) to networks (e.g., to the network 845, or any other local area, wide area or other network), mass storage, display devices, data entry devices and/or the like.

The processor 805 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 806 represents any non-transitory short or long term storage or other computer-readable media capable of storing programming instructions for execution on the processor 805, including any sort of random access memory (RAM), read only memory (ROM), flash memory, magnetic or optical mass storage, and/or the like. The computer-executable programming instructions, when read and executed by the server 802 and/or processors 805, cause the server 802 and/or processors 805 to create, generate, or otherwise facilitate the app platform 810 and/or virtual apps 828 and perform one or more additional tasks, operations, functions, and/or processes described herein. It should be noted that the memory 806 represents one suitable implementation of such computer-readable media, and alternatively or additionally, the server 802 could receive and cooperate with external computer-readable media that is realized as a portable or mobile component or platform, e.g., a portable hard drive, a USB flash drive, an optical disc, or the like.

The app platform 810 is any sort of software app or other data processing engine that generates the virtual apps 828 including apps relating to arranging graphic elements in user interfaces that provide data and/or services to the tenant devices 840. In a typical embodiment, the app platform 810 gains access to processing resources, communications interface and other features of the processing hardware 804 using any sort of conventional or proprietary operating system 808. The virtual apps 828 are typically generated at run-time in response to input received from the tenant devices 840. For the illustrated embodiment, the app platform 810 includes a bulk data processing engine 812, a query generator 814, a search engine 816 that provides text indexing and another search functionality, and a runtime app generator 820. Each of these features may be implemented as a separate process or other module, and many equivalent embodiments could include different and/or additional features, components or other modules as desired.

The runtime app generator 820 dynamically builds and executes the virtual apps 828 in response to specific requests received from the tenant devices 840. The virtual apps 828 are typically constructed in accordance with the tenant-specific metadata 838, which describes the tables, reports, interfaces and/or other features of the app 828. In various embodiments, each virtual app 828 generates dynamic web content that can be served to a browser or another tenant program 842 associated with its tenant device 840, as appropriate.

The runtime app generator 820 suitably interacts with the query generator 814 to efficiently obtain data 832 from the multi-tenant database 830 as needed in response to input queries initiated or otherwise provided by users of the tenant devices 840. In a typical embodiment, the query generator 814 considers the identity of the user requesting a particular function (along with the user's associated tenant), and then builds and executes queries to the multi-tenant database 830 using system-wide metadata 836, tenant specific metadata, pivot tables 834, and/or any other available resources. The query generator 814 in this example therefore maintains security of the common database by ensuring that queries are consistent with access privileges granted to the user and/or tenant that initiated the request.

With continued reference to FIG. 8, the bulk data processing engine 812 performs bulk processing operations on the data 832 such as uploads or downloads, updates, online transaction processing, and/or the like. In many embodiments, less urgent bulk processing of the data 832 can be scheduled to occur as processing resources become available, thereby giving priority to more urgent data processing by the query generator 814, the search engine 816, the virtual apps 828, etc.

In exemplary embodiments, the app platform 810 is utilized to create and/or generate data-driven virtual apps 828 for the tenants that they support. Such virtual apps 828 may make use of interface features such as custom (or tenant-specific) screens 824, standard (or universal) screens 822 or the like. Any number of custom and/or standard objects 826 may also be available for integration into tenant-developed virtual apps 828. As used herein, “custom” should be understood as meaning that a respective object or app is tenant-specific (e.g., only available to users associated with a particular tenant in the multi-tenant system) or user-specific (e.g., only available to a particular subset of users within the multi-tenant system), whereas “standard” or “universal” apps or objects are available across multiple tenants in the multi-tenant system.

The data 832 associated with each virtual app 828 is provided to the multi-tenant database 830, as appropriate, and stored until it is requested or is otherwise needed, along with the metadata 838 that describes the particular features (e.g., reports, tables, functions, objects, fields, formulas, code, etc.) of that particular virtual app 828. For example, a virtual app 828 may include several objects 826 accessible to a tenant, wherein for each object 826 accessible to the tenant, information pertaining to its object type along with values for various fields associated with that respective object type are maintained as metadata 838 in the multi-tenant database 830. In this regard, the object type defines the structure (e.g., the formatting, functions and other constructs) of each respective object 826 and the various fields associated therewith.

Still referring to FIG. 8, the data and services provided by the server 802 can be retrieved using any sort of personal computer, mobile telephone, tablet or another network-enabled tenant device 840 on the network 845. In an exemplary embodiment, the tenant device 840 includes a display device, such as a monitor, screen, or another conventional electronic display capable of graphically presenting data and/or information retrieved from the multi-tenant database 830, as described in greater detail below.

Typically, the user operates a conventional browser app or other tenant program 842 executed by the tenant device 840 to contact the server 802 via the network 845 using a networking protocol, such as the hypertext transport protocol (HTTP) or the like. The user typically authenticates his or her identity to the server 802 to obtain a session identifier (“Session ID”) that identifies the user in subsequent communications with the server 802. When the identified user requests access to a virtual app 828, the runtime app generator 820 suitably creates the app at run time based upon the metadata 838, as appropriate. However, if a user chooses to manually upload an updated file (through either the web based user interface or through an API), it will also be shared automatically with all the users/devices that are designated for sharing.

As noted above, the virtual app 828 may contain Java, ActiveX, or other content that can be presented using conventional tenant software running on the tenant device 840; other embodiments may simply provide dynamic web or other content that can be presented and viewed by the user, as desired. As described in greater detail below, the query generator 814 suitably obtains the requested subsets of data 832 from the multi-tenant database 830 as needed to populate the tables, reports or other features of the particular virtual app 828. In various embodiments, app 828 embodies the functionality of apps for arranging graphic elements in right and left configurations, as described previously in connection with FIGS. 1-7.

Techniques and technologies may be described herein in terms of functional and/or logical block components, and with references to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits.

It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The various tasks performed in connection with arranging the graphic elements on the display of the device may be performed by software, hardware, firmware, or any combination thereof. For illustrative purposes, the following description of detecting operations, arranging the graphic elements, determining configurations, and data analysis may refer to elements mentioned above in connection with FIGS. 4 and 5. In practice, portions of process of FIGS. 4 and 5 may be performed by different elements of the described system, e.g., mobile clients, apps etc.

It should be appreciated that the processes of FIGS. 4 and 5 may include any number of additional or alternative tasks, the tasks shown in FIGS. 4 and 5 need not be performed in the illustrated order, and the processes of the FIGS. 4 and 5 may be incorporated into a more comprehensive procedure or process having additional functionality not described in detail herein. Moreover, one or more of the tasks shown in FIGS. 4 and 5 could be omitted from an embodiment as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description. While at least one exemplary embodiment has been presented in the foregoing detailed description, it should be appreciated that a vast number of variations exist.

It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. The various changes can be made in the function and arrangement of elements without departing from the scope defined by the claims, which includes known equivalents and foreseeable equivalents at the time of filing this patent application.

What is claimed is:

1. A method for arranging, on a display of a device, graphic elements within a user interface (UI) requiring a touch for selection, wherein the device has an edge to edge sensor display comprising sense elements, the method comprising:
receiving, from the sense elements, signals indicative of whether the device is in a right hand or in a left hand of the user;
determining by the signals which have been received and user touch whether the user is making single-handed selections by touch for selecting graphic elements within the UI using the right hand or left hand wherein the signals are generated by the sense elements from contact of the right hand or left hand of the user when holding the device;
arranging the graphic elements of the UI, to allow for single handed selections with a greater ease by the user in the right hand or left hand by arranging in a first arrangement, the graphic elements for accessing by fingers of the right hand of the user and in a second arrangement, the graphic elements for accessing by fingers of the left hand; and
arranging the graphic elements in a default arrangement when the determining step fails to determine from the signals whether the device is in the right hand or the left hand of the user.

2. The method of claim 1, wherein the graphic elements comprise at least one of: pointers, icons, and/or menus for selection by touch by the user.

3. The method of claim 1, wherein graphic elements comprise more than one state actionable upon the touch of the graphic element by the user.

4. The method of claim 1, comprising:
defining a target area for the graphic elements for both the first arrangement and second arrangement where the target area is a region of a display defined where the graphic elements of the first arrangement and second arrangements are substantially accessible by touch of the user while making single handed selections by the right hand or the left hand.

5. The method of claim 1, wherein the sense elements comprise at least one of capacitive, optical, force, infra-red, accelerometer and gyroscopic type elements generating signals from touches in the edge to edge sensor display, and/or motions of the device.

6. The method of claim 1, wherein the arranging step is executed by a set of instructions integrated into an operating system of the device, an associated app within the UI of the device, or at a remote server.

7. The method of claim 1, comprising:
capturing metrics related to the first and second arrangements for assessing the single handed selections by the user of accessing the graphic elements in the first arrangement and second arrangement, and for rearranging the graphic elements in the first arrangement and second arrangement to improve the ease of single handed selections.

8. A computer program product tangibly embodied in a computer-readable storage device and comprising instructions that when executed by a processor perform a method for arranging a graphic element on a display of a device, the method comprising:
displaying a graphic element at a first location within a region of the display of the device;
selecting a second location for the graphic element within a region of the display of the device wherein a change from the first location to the second location is in response to an action on the part of the user; and
changing the graphic element from within the region of the first location to within the region of the second location wherein the region of the second location enables the graphic element to be more accessible by touch when the user is operating the device using a single hand for both holding the device and for selecting the graphic element by the touch.

9. The method of claim 8, wherein the graphic element comprises at least one of the following: pointers, icons, and/or menus for selecting by touch.

10. The method of claim 8, comprising:
detecting by a sensor the touch of the user for response wherein the sensor comprises at least one of capacitive, optical, force, infra-red, accelerometer and gyroscope located in a vicinity of the display of the device.

11. The method of claim 10, wherein the touch of the user which is detected by the sensors comprises one or more actions related to a touch on the display of the device and/or a movement of the device while using the single hand to operate the device.

12. The method of claim 11, comprising:
defining a target area for placing the graphic elements within the region of the second location to enable accessing substantially all the graphic elements by touch by the user while using the single hand to operate the device.

13. The method of claim 8, wherein the set of instructions is integrated into an operating system of the device, an associated app within an UI of the device, or at a remote server.

14. The method of claim 8, comprising:
capturing data related to changing the graphic element from with the region of the first location to the region of the second location for assessing accessibility of the graphic element by touch of the while using the single hand to operate the device.

15. A system for arranging graphic elements on a display of a device, comprising:
one or more processors;
at least one sensor;
a display which covers a face and at least part of an edge of the device,
a touch screen including at least the one sensor disposed on the face of the display;
an application comprising computer-readable instructions operative, when executed, to cause the one or more processors in response to a touch event sensed by at least the one sensor from the touch screen of the display of the device during executing of an app within a user interface wherein the app is represented by a graphic element about the display to select an arrangement for the graphic element in the user interface based on the touch event: to process one or more related applications to the user interface based in part on the arrangement for the graphic element which has been selected, for a configuration which enables single handed use by the arrangement.

16. The system of claim 15, wherein the graphic element comprises at least one of: pointers, icons, and/or menus for selection by touch of a user.

17. The system of claim 15 wherein the sensor comprises at least one of a capacitive, optical, force, infra-red, accelerometer and gyroscope which is responsive to the touch event on the face and at least part of the edge of the display, and/or motions of the device.

18. The system of claim 15 wherein the set of instructions is integrated into an operating system of the device, an associated app within the user interface of the device, or at a remote server.

19. The system of claim 15, the related applications further comprising:
an analysis application to capture data of the arrangement which is selected for the graphic element in the user interface based on the touch event and for assessing the single handed use which has been enabled by the arrangement.

20. The system of claim 15, the configuration further comprising:
a first configuration for the single handed use by a right hand; and
a second configuration for the single handed use by a left hand.
